(19) United States
(12) Patent Application Publication
(10) Pub. No.: US 2026/0075556 A1
(43) Pub. Date: Mar. 12, 2026

(54) WIRELESS EARBUDS, SYSTEM AND OPERATION METHOD THEREFOR

(71) Applicant: LG ELECTRONICS INC., Seoul (KR)

(72) Inventors: Jinseong LEE, Seoul (KR); Byounghak JEONG, Seoul (KR)

(73) Assignee: LG ELECTRONICS INC., Seoul (KR)

(21) Appl. No.: 19/107,495

(22) PCT Filed: Aug. 31, 2022
(86) PCT No.: PCT/KR2022/013032

§ 371 Date: Feb. 27, 2025

(51) Int. Cl. H04W 56/00; H04R 5/033

(52) U.S. Cl. CPC H04W 56/0015; H04R 5/033; H04W 56/002; H04R 2420/07

(57) ABSTRACT

Wireless earbuds, a system, and an operation method therefor are disclosed. The wireless earbuds according to at least one of various embodiments of the present disclosure comprise: a first synchronization device for receiving audio data from a source device; and a second sink device for snooping the audio data transmitted from the source device, wherein the first synchronization device can transmit synchronization information related to the replay of a data packet to the second synchronization device.

### TECHNICAL FIELD

The present disclosure relates to wireless earbuds, a system, and an operation method thereof. More specifically, it relates to a playback sync synchronization and clock drift processing method in wireless earbuds.

### BACKGROUND ART

Due to the development of communication technology, miniaturization of batteries, and improvement in capacity, the number of users using wireless earbuds instead of wired earphones is rapidly increasing. In other words, the use of True Wireless Stereo (TWS) is increasing.

A wireless earbud system is composed of a source device such as a smartphone and at least one earbud that receives sound from the source device. In particular, it is preferable to wear the earbuds on the left and right sides, and it is generally composed of two, one of which is an earbud master that receives sound directly from the source device, and the other is an earbud slave that can operate in a manner of snooping sound received from the source device to the earbud master.

On the other hand, when some data is not received from the earbud slave, data relay may be required, and in this case, there is a problem that a delay occurs and the battery is unnecessarily consumed.

### DETAILED DESCRIPTION OF THE INVENTION

### Technical Problem

The present disclosure aims to provide a wireless earbud, a system, and an operating method thereof that minimize the occurrence frequency and delay time of data relay between earbuds and minimize battery consumption.

The present disclosure aims to provide a method for aligning playback sync between earbuds and handling clock drift between a source device and the earbuds.

### Technical Solution

A wireless earbud according to at least one embodiment of various embodiments of the present disclosure may include a first sink device configured to receive audio data from a source device; and a second sink device configured to snoop the audio data transmitted from the source device, wherein the first sink device is configured to transmit synchronization information related to the playback of a data packet to the second sink device.

According to at least one embodiment of the various embodiments of the present disclosure, the first sink device may include the synchronization information in a control packet transmitted to the second sink device.

According to at least one embodiment of the various embodiments of the present disclosure, the synchronization information may include at least one of a data packet sequence number and information on a playback time.

According to at least one embodiment of the various embodiments of the present disclosure, the synchronization information may further include information on sample control.

According to at least one embodiment of the various embodiments of the present disclosure, the control packet may be a True Wireless Stereo end control packet.

According to at least one embodiment of the various embodiments of the present disclosure, the data packet sequence number information may indicate a reference sequence number of a data packet to which the synchronization information is applied.

According to at least one embodiment of the various embodiments of the present disclosure, the reference sequence of the data packet to which the synchronization information is applied may be a first sequence of the data packet to which the synchronization information is applied.

According to at least one embodiment of the various embodiments of the present disclosure, the playback time information may indicate a time point where the reference sequence of the data packet is actually played.

According to at least one embodiment of the various embodiments of the present disclosure, the playback time information may be defined using network time applied between the first sink device and the second sink device.

According to at least one embodiment of the various embodiments of the present disclosure, the synchronization information may be defined considering a retransmission interval due to a snooping failure of the second sink device.

According to at least one embodiment of the various embodiments of the present disclosure, the second sink device may be configured to discard a data packet having a sequence number earlier than the reference sequence number of the data packet to which the synchronization information is applied.

According to at least one embodiment of the various embodiments of the present disclosure, when a data packet corresponding to the synchronization information is not received, the second sink device may be configured to process the corresponding packet as silent.

According to at least one embodiment of the various embodiments of the present disclosure, the first sink device may be configured to compare the network time applied between the source device with a clock of a controller and when the difference exceeds a threshold, and perform a correction operation based on the sample control information, wherein the threshold may be determined based on an audio sample of Pulse-code modulation (PCM) data, and wherein the sample control information may include: when the clock of the controller is faster than the network time, duplicate control information including at least one sample in the PCM data, and when the clock of the controller is slower than the network time, deletion control information including at least one sample in the PCM data.

According to at least one embodiment of the various embodiments of the present disclosure, a method of operating a wireless earbud may comprise receiving audio data from a source device at a first sink device; snooping the audio data transmitted from the source device to the first sink device at a second sink device; and transmitting synchronization information related to the playback of a data packet from the first sink device to the second sink device.

According to at least one embodiment of the various embodiments of the present disclosure, a wireless earbud system may comprise a source device; a first sink device configured to receive audio data from the source device; and a second sink device configured to snoop the audio data transmitted from the source device, wherein the first sink device may be configured to transmit synchronization information related to the playback of a data packet to the second sink device.

### Effect of the Invention

According to at least one of the various embodiments of the present disclosure, since the earbud master selectively transmits only the data that has not been received from the earbud slave to perform data relay, the relay frequency and delay time are minimized, and accordingly, battery efficiency is improved, which is advantageous.

According to at least one of the various embodiments of the present disclosure, it is advantageous that the error in the reproduction time can be improved so that it is absent or minimized, and the increase in the error in the reproduction time is improved even during long-term operation, which can improve the convenience of using the earbud.

### BRIEF DESCRIPTION OF THE DRAWINGS

FIG. 1 is a schematic diagram of a wireless earbud system according to an embodiment of the present disclosure.

FIG. 2 is a diagram illustrating an example of a TWS Control/Relay Packet format transmitted and received between earbuds in a wireless earbud system according to an embodiment of the present disclosure.

FIG. 3 is a diagram illustrating a payload format of a TWS Initial Control Packet according to an embodiment of the present disclosure.

FIG. 4 is a diagram illustrating a payload format of a TWS Start Control Packet according to an embodiment of the present disclosure.

FIG. 5 is a diagram illustrating a payload format of a TWS Reply Control Packet according to an embodiment of the present disclosure.

FIG. 6 is a diagram illustrating a payload format of a TWS End Control Packet according to an embodiment of the present disclosure.

FIG. 7 is a flowchart illustrating an operation method when a data relay of a wireless earbud system according to an embodiment of the present disclosure is not required.

FIG. 8 and FIG. 9 are flowcharts illustrating an operation method when a data relay of a wireless earbud system according to an embodiment of the present disclosure is required.

FIG. 10 is a control block diagram of an earbud slave device according to an embodiment of the present disclosure.

FIG. 11 is a flowchart illustrating a method for an earbud slave device according to an embodiment of the present disclosure to determine duplicate reception of an ACL data packet and operate.

FIG. 12 is a flowchart illustrating a process of forming a TWS control link between an earbud master and an earbud slave according to an embodiment of the present disclosure.

FIG. 13 and FIG. 14 are flowcharts illustrating a connection and information exchange method between earbuds according to an embodiment of the present disclosure.

FIG. 15 is a flowchart illustrating a method for normally transmitting and receiving data using heterogeneous link technology in a wireless earbud system according to an embodiment of the present disclosure.

FIG. 16 is a diagram illustrating a data transmission/reception and ACK timing diagram according to FIG. 15.

FIG. 17 is a diagram illustrating a case in which only the earbud master does not receive data when using heterogeneous link technology in a wireless earbud system according to an embodiment of the present disclosure.

FIG. 18 is a diagram illustrating a data transmission/reception and ACK timing diagram according to FIG. 17.

FIG. 19 is a diagram illustrating a case in which only the earbud slave does not receive data when using heterogeneous link technology in a wireless earbud system according to an embodiment of the present disclosure.

FIG. 20 is a diagram illustrating a data transmission/reception and ACK timing diagram according to FIG. 19.

FIG. 21 is a flowchart illustrating a case where neither the earbud master nor the earbud slave receive data when utilizing heterogeneous link technology in a wireless earbud system according to an embodiment of the present disclosure.

FIG. 22 is a diagram illustrating a data transmission/reception and ACK timing diagram according to FIG. 21.

FIG. 23 is a diagram illustrating a synchronization error in a wireless earbud system according to an embodiment of the present disclosure.

FIG. 24 is a diagram illustrating a payload format of a TWS end control packet according to another embodiment of the present disclosure.

FIG. 25 is a control block diagram of an earbud master device according to an embodiment of the present disclosure.

FIG. 26 is a control block diagram of an earbud slave device according to an embodiment of the present disclosure.

FIG. 27 is a flowchart illustrating an operation method in the case of initial clock synchronization of a wireless earbud system according to an embodiment of the present disclosure.

FIG. 28 is a flowchart illustrating an operation method in the case of initial clock synchronization of a wireless earbud system according to another embodiment of the present disclosure.

FIG. 29 is a flowchart illustrating an operation method in the case of clock fine tuning of a wireless earbud system according to an embodiment of the present disclosure.

FIG. 30 is a drawing illustrating an appearance of capturing packets with an air sniffer device when data relay is not required in a wireless earbud system according to an embodiment of the present disclosure.

FIG. 31 is a drawing illustrating an appearance of capturing packets with an air sniffer device when data relay is required in a wireless earbud system according to an embodiment of the present disclosure.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

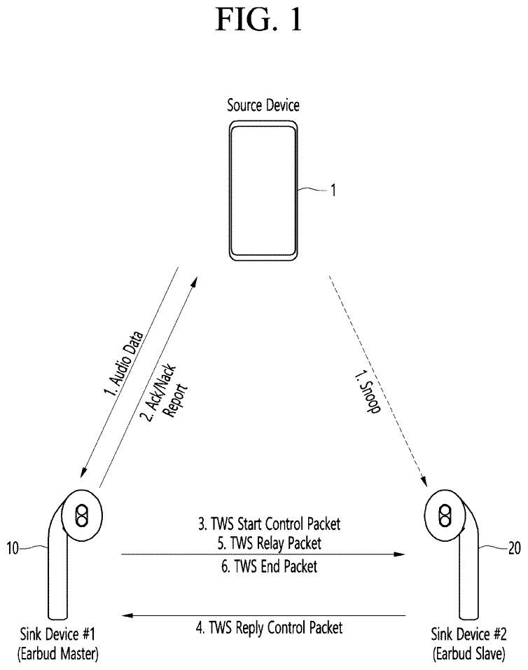

FIG. 1 is a schematic diagram of a wireless earbud system according to an embodiment of the present disclosure.

The wireless earbud system according to an embodiment of the present disclosure is composed of a source device 1 and a sink device, and the sink device may include a first sink device 10 and a second sink device 20. One of the first and second sink devices 10, 20 may be an earbud master, and the other may be an earbud slave. In the following disclosure, it is assumed that the first sink device 10 is a master device and the second sink device 20 is a slave device, but this is only an example for convenience of explanation, and thus it is reasonable that the present disclosure is not limited thereto.

FIG. 1 schematically describes an operation method of a wireless earbud system.

The source device 1 may transmit audio data to the earbud master 10. The earbud master 10 can receive audio data from the source device 1. The earbud master 10 can transmit a message such as ACK or NACK to the source device 1 depending on the reception status of the audio data. If the earbud master 10 normally receives the audio data, it can transmit an ACK message to the source device 1, and if it does not normally receive the audio data, it can transmit a NACK message to the source device 1.

Meanwhile, the earbud slave 20 can snoop on audio data transmitted from the source device 1 to the earbud master 10. Snooping can mean an operation of intercepting data on a network.

Through such an operation, the earbud master 10 and the earbud slave 20 can obtain data from the source device 1 for a predetermined period of time.

Afterwards, the first and second sink devices 10, 20 can share data reception status information from the source device 1 using a True Wireless Stereo (TWS) control packet. Specifically, the TWS control packet can include a TWS Start Control Packet and a TWS Reply Control Packet. When the earbud master 10 transmits a TWS Start Control Packet to the earbud slave 20, the earbud slave 20 can transmit a TWS Reply Control Packet to the earbud master 10, thereby exchanging data reception status information. The Logical Link IDentifier (LLID) value of the payload of the start control packet can be ‘0’.

The earbud master 10 can transmit a start control packet including the reception status information of Asynchronous Connection-Less (ACL) data received from the source device 1 to the earbud slave 20, and can receive a reply control packet including the reception status information of ACL data snooped by the earbud slave 20 from the earbud slave 20.

The earbud master 10 can determine whether to perform data relay based on the data reception status information received from the earbud slave 20. The earbud master 10 can determine whether to perform data relay operation by comparing the ACL data received from the source device 1 with the ACL data received by the earbud slave 20 through the reply control packet.

The earbud master 10 can selectively control the earbud slave 20 to perform data relay based on the determination of data relay. The earbud master 10 can transmit a TWS Relay Packet to the earbud slave 20 so that the earbud slave 20 can perform data relay. When a data relay operation is required, the earbud master 10 can transmit a relay packet, which transmits data that the earbud slave 20 failed to snoop from the ACL data buffer, to the earbud slave 20. The TWS Relay Packet can include a packet payload that the earbud slave 20 failed to snoop. The TWS Relay Packet can be configured with a payload that the earbud master 10 received from the source device 1.

When the earbud slave 20 receives a TWS Relay Packet, it can transmit a Null Packet in response thereto, and the Null Packet can include an ACK message.

The earbud master 10 transmits all TWS relay packets that should be data relays, and when an ACK message is received in response, the earbud master 10 can generate a TWS end packet and transmit it to the earbud slave 20. That is, the earbud master 10 can transmit an end packet to the earbud slave 20 when the data relay operation is not required or when the data relay operation is completed.

According to this, the earbud master 10 selectively performs data relay only for data that the earbud slave 20 has not snooped, thereby improving the delay time and minimizing the data relay operation compared to the method in which data is relayed from the source device 1, and thus has the advantage of minimizing battery consumption.

Accordingly, the present disclosure can transmit a relay packet to the earbud slave 20 to perform a data relay operation when there is data for which snooping failed in the earbud slave 20. In addition, a control link for transmitting and receiving a relay packet between the earbud master 10 and the earbud slave 20 can be formed.

The control link can be a TWS control link. The TWS control link can apply its own operation protocol (Protocol) and its own access code generation method to the TWS Control/Relay Packet, and can enhance the security of the TWS Control Link operation between earbuds.

Next, packets transmitted and received in the wireless earbud system according to the embodiment of the present disclosure will be described in detail.

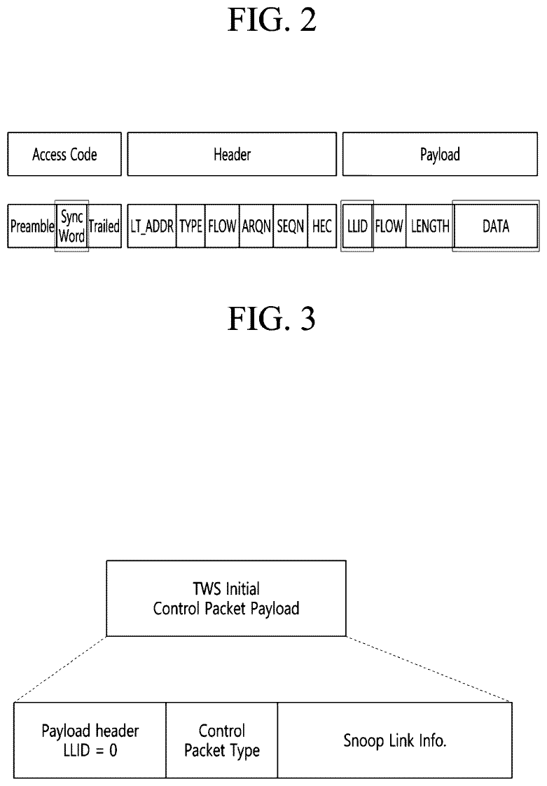

FIG. 2 is a diagram illustrating an example of a TWS Control/Relay Packet format transmitted and received between earbuds in the wireless earbud system according to the embodiment of the present disclosure.

The wireless earbud system according to the embodiment of the present disclosure can generate a TWS control link between earbuds according to the self-protocol method proposed in the present disclosure, and can transmit and receive a TWS Control/Relay packet for exchanging TWS control information between earbuds in the generated TWS control link.

The TWS control link can be a self-control link for exchanging TWS control packets and TWS relay packets between earbuds. In addition, the present disclosure can define a TWS control packet for exchanging a data reception status from a source device 1 and control information for controlling a snooping link of an earbud slave 20.

The TWS Control/Relay packet may have a format as shown in FIG. 2. Specifically, the TWS Control/Relay packet uses the Undefined Value (0) among the LLID Field values to generate the DATA area of the Payload for TWS control packets with LLID=‘0’ by the self-protocol method proposed in this disclosure, and the Sync Word Field of the Access Code is generated by the self-protocol method proposed in this disclosure, thereby eliminating the possibility of conflict between the TWS Control Link operation between earbuds and the standard ACL Link operation, and enhancing the security of the TWS Control Link operation between earbuds.

The format of the TWS Control packet is specifically described as follows.
In order to allow connection only with the company's products, enhance security, and prevent Access Code Detection False Alarm, the Sync Word generation method of the Access Code may be generated by the company's own method without following the Bluetooth standard.
The LLID value of the payload can be distinguished from the LMP, ACL Data Packet suggested by the BlueTooth™ standard by using the value of LLID=‘0’ which is not used in the standard (to prevent conflicts with LMP/ACL Link related operations).
The TWS Control Link control operation is performed according to the protocol method defined by the controller using the TWS Control Packet with LLID=‘0’.
The delay time can be improved by quickly processing the TWS control packet transmission/reception operation and the subsequent TWS control link control operation in the controller.
The DATA Field of the payload is composed of information defined for each TWS Control Packet so that the TWS control link control procedure can be performed according to the self-defined protocol.

The format of the TWS relay packet is specifically described as follows.
Only allow connection with the company's own products, and in order to enhance security and prevent Access Code Detection False Alarm, the method of generating the Access Code's Sync Word does not follow the Bluetooth™ standard, but is generated using the company's own method.
The Payload section is composed of the same information as the payload of the ACL data packet received by the earbud master 10 from the source device 1 for the ACL data packet that the earbud slave 20 could not snoop on.

The Sync Word generation method can be as follows.
The local/global bit of the Bluetooth device address used as input for Sync Word generation is inverted from the original value to generate the Sync Word.

Hereinafter, the payload format of the TWS control packet and the TWS relay packet will be described in detail.

FIG. 3 is a diagram illustrating the payload format of the TWS Initial Control Packet according to an embodiment of the present disclosure.

The TWS Initial Control Packet may represent a TWS control packet that the earbud master 10 initially transmits to the earbud slave 20.

The TWS Initial Control Packet may include ACL link information and timing information between the earbud master 10 and the source device 1 for the earbud slave 20 to snoop on the source device 1.

The payload format of the TWS Initial Control Packet may be as illustrated in FIG. 3. That is, the payload of the TWS initial control packet may include a header LLID of ‘0’ and a control packet type and snoop link information. At this time, the snoop link information may include the following information.
ACL link information formed between the source device 1 and the earbud master 10
The last RxSequN, RxArqN, and Rx Payload counter information of the earbud master 10
Clock Offset and Slot Boundary Offset information between the source device 1 and the earbud master 10.

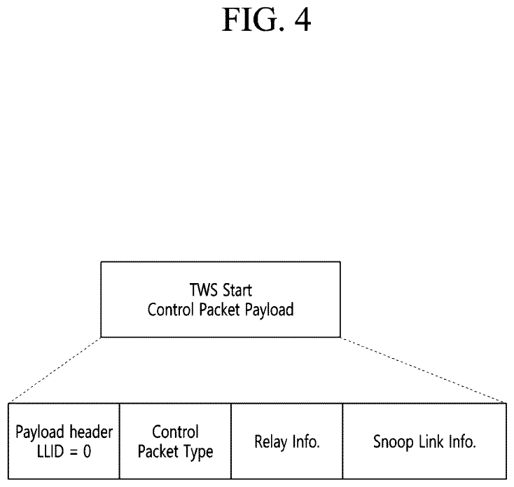

FIG. 4 is a diagram illustrating a payload format of a TWS Start Control Packet according to an embodiment of the present disclosure.

The TWS start control packet may represent a TWS control packet that the earbud master 10 transmits to the earbud slave 20 after the TWS initial control packet. The TWS start control packet may be a packet that transmits ACL data reception status information received from the source device 1 by the earbud master 10 to the earbud slave 20.

The payload format of the TWS start control packet may be as shown in FIG. 4. That is, the payload header LLID of the TWS start control packet may be ‘0’ and may include a control packet type, relay information, and snooping link information. At this time, the relay information may include the following information.
TWS Control Session Number
SEQ_NUM: The number of accumulated ACL data successfully received from the source device 1
PKT_CNT: The number of ACL data successfully received during the previous source device 1 reception section
LMP/ACL Tx Data Pending Flag: A flag indicating that there is LMP/ACL Tx Data pending from the earbud master 10

And, the snooping link information may include the following information.
RxSeqN, RxArqN, Rx Payload Counter: Parameters that the earbud slave 20 should use when receiving ACL Data in the next Snoop Link
AFH Channel Map: If the AFH Channel Map is changed, it is transmitted to the earbud slave 20.

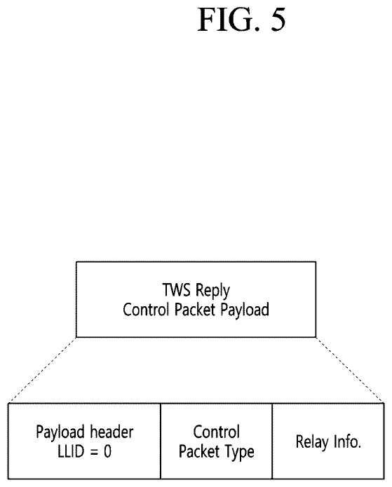

FIG. 5 is a diagram illustrating a payload format of a TWS Reply Control Packet according to an embodiment of the present disclosure.

The TWS Reply Control Packet may be a packet that transmits reception status information of ACL data snooped by the earbud slave 20 from the source device 1 to the earbud master 10.

The payload format of the TWS Reply Control Packet may be as illustrated in FIG. 5. That is, the payload header LLID of the TWS Reply Control Packet may be ‘0’ and may include a control packet type and relay information. At this time, the relay information may include the following information.
TWS Control Session Number
SEQ_NUM: The number of accumulated ACL data successfully snooped from the source device 1
PKT_CNT: The number of ACL data successfully received during the previous source device 1 snooping period
LMP/ACL Tx Data Pending Flag: A flag indicating that there is pending LMP/ACL Tx Data in the earbud slave 20.

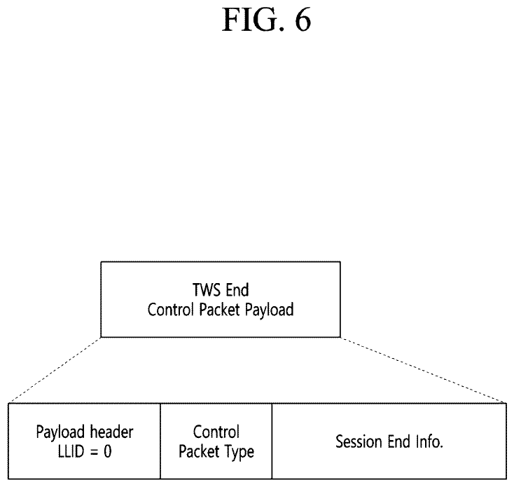

FIG. 6 is a diagram illustrating a payload format of a TWS End Control Packet according to an embodiment of the present disclosure.

The TWS End Control Packet may be a packet that the earbud master 10 transmits to the earbud slave 20 that data relay is not needed or that data relay operation is completed.

The payload format of the TWS End Control Packet may be as illustrated in FIG. 6. That is, the payload header LLID of the TWS end control packet is ‘0’ and may include the control packet type and session end information. At this time, the session end information may include the following information.
TWS Control Session Number
No Data Replay Action Flag: A flag indicating that data relay operation is not required
Ongoing ACL Action Flag: A flag indicating that ACL link operation between earbuds is required following the termination of the TWS control link operation.

Meanwhile, the TWS relay packet may be a packet transmitted from the earbud master 10 to the earbud slave 20 so that the earbud slave 20 performs a selective data relay operation for data that it was unable to snoop.

Specifically, after receiving a TWS reply control packet from an earbud slave 20, the earbud master 10 can determine whether a data relay operation of the earbud slave 20 is necessary based on its own relay information and the relay information received from the earbud slave 20. The earbud master 10 can determine that the data relay operation is not necessary if both the first case where the SEQ_NUM of the earbud slave 20 is greater than or equal to the SEQ_NUM of the earbud master 10 and the second case where the PKT_NUM of the earbud slave 20 is greater than or equal to the PKT_NUM of the earbud master 10 are satisfied. Meanwhile, the earbud master 10 can determine that the data relay operation is necessary if neither of the first and second cases described above is satisfied.

When the earbud master 10 determines that a data relay operation is necessary, it can transmit to the earbud slave 20 through a TWS relay packet containing data that the earbud slave 20 was unable to snoop from the received ACL data buffer stored in the earbud master 10. The earbud slave 20 can selectively perform a data relay operation using the TWS relay packet.

Next, the operation method of the wireless earbud system is described in detail. The wireless earbud system can selectively perform a data relay.

The earbud master 10 performs an ACL link operation for receiving an ACL data packet transmitted from a source device 1 for a predetermined period of time, the earbud slave 20 performs a snooping link operation for receiving an ACL data packet while the earbud master 10 performs the ACL link operation, and when the earbud master 10 and the earbud slave 20 complete the receiving operation for the ACL data packet, they can switch the TWS control link operation.

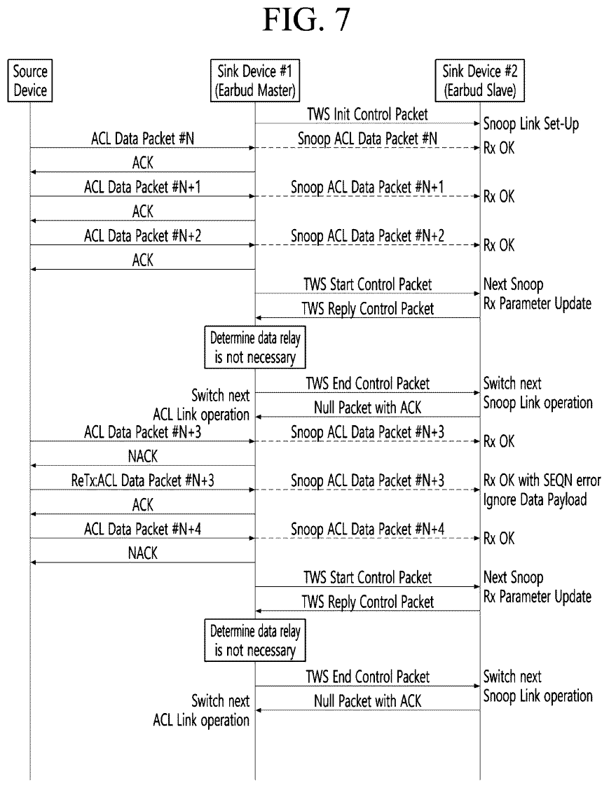

FIG. 7 is a flowchart illustrating an operation method when a data relay of a wireless earbud system according to an embodiment of the present disclosure is not required.

First, a TWS control link can be formed between an earbud master and an earbud slave. That is, a TWS control link can be formed between an earbud master 10 and an earbud slave 20.

After forming a TWS control link, the earbud slave 20 can receive a TWS initial control packet and receive a snooping link parameter (Snoop Link Parameter) required for configuring a snooping link from the earbud master 10 through the TWS initial control packet. The earbud slave 20 can perform a snooping link setup procedure through the snooping link parameter. Accordingly, the earbud slave 20 can form a snooping link.

The earbud master 10 and the earbud slave 20 can attempt to receive the ACL data packet transmitted from the source device 1 for a predetermined period.

Specifically, the earbud master 10 can feed back the ACK/NACK result for the success/failure of receiving the ACL data packet to the source device 1 and update the reception status information of the ACL data packet for configuring the relay information transmitted in the TWS start control packet.

In addition, the earbud slave 20 can perform a snooping operation on the ACL data packet from the source device 1 and update the reception status information of the ACL data packet for configuring the relay information transmitted in the TWS reply control packet.

When the earbud master 10 and the earbud slave 20 complete the reception operation for the ACL data packet transmitted from the source device 1 for a predetermined period, they can switch to the TWS control link operation.

Specifically, the earbud master 10 can generate payload information of a TWS start control packet and transmit the packet to the earbud slave 20. The earbud slave 20 can generate payload information of a TWS reply control packet and transmit the TWS reply control packet to the earbud master 10 in response to receiving the TWS start control packet from the earbud master 10. The earbud slave 20 can update Rx parameter (ARQN, SEQN, Payload counter, AFH Channel Map) information for the reception operation of the next snooping link according to the snooping information of the received TWS start control packet.

The earbud master 10 receives the TWS reply control packet transmitted from the earbud slave 20, and based on the relay information of the corresponding payload, can determine whether the earbud slave 20 has data for which snooping has failed.

The earbud master 10 can determine that if there is no data for which snooping has failed, data relay is not necessary, and if there is data for which snooping has failed, data relay is necessary.

In the case of FIG. 7, it is assumed that the earbud master 10 has determined that the earbud slave 20 has no data for which snooping has failed, and thus data relay is not necessary.

The earbud master 10 can determine that data relay is not necessary, generate a payload of a TWS end control packet that transmits this, and transmit the generated packet to the earbud slave 20.

The earbud slave 20 receives a TWS end control packet, and determines that the data relay operation is not necessary based on the No Data Relay Action Flag information among the payload information of the packet, and can switch to a snooping link operation for receiving an ACL data packet from the source device 1.

When the earbud master 10 receives a null packet (including an ACK) in response to the transmitted TWS end control packet, the TWS control link operation can be terminated, and can switch to an ACL link operation for receiving an ACL data packet from the source device 1.

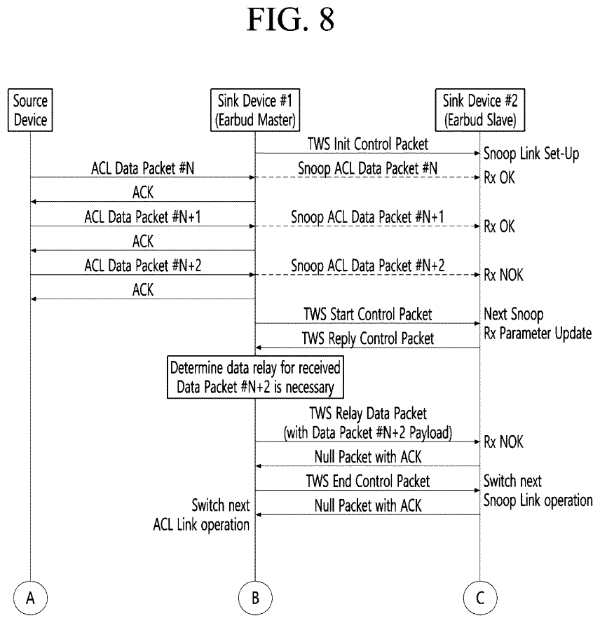

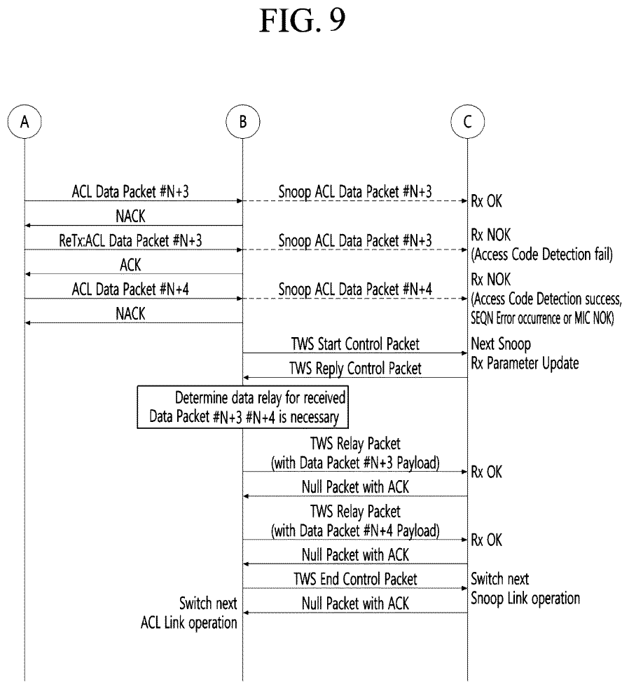

FIG. 8 and FIG. 9 are flowcharts illustrating an operation method when data relay of a wireless earbud system according to an embodiment of the present disclosure is required.

First, a TWS control link can be formed between the earbud master and the earbud slave.

After forming a TWS control link, the earbud slave 20 can receive a TWS initial control packet and receive snooping link parameters required for configuring a snooping link from the earbud master 10 through the TWS initial control packet. The earbud slave 20 can perform a snooping link setup procedure through the snooping link parameters. Accordingly, the earbud slave 20 can form a snooping link.

The earbud master 10 and the earbud slave 20 can attempt to receive an ACL data packet transmitted from the source device 1 for a predetermined period.

Specifically, the earbud master 10 can feed back the ACK/NACK result for the success/failure of receiving the ACL data packet to the source device 1 and update the reception status information of the ACL data packet for configuring the relay information transmitted in the TWS start control packet.

Then, the earbud slave 20 can perform a snooping operation on the ACL data packet from the source device 1 and update the reception status information of the ACL data packet for configuring the relay information transmitted in the TWS reply control packet.

When the earbud master 10 and the earbud slave 20 complete the reception operation for the ACL data packet transmitted from the source device 1 for a predetermined period, they can switch to the TWS control link operation.

Specifically, the earbud master 10 can generate payload information of a TWS start control packet and transmit the packet to the earbud slave 20. The earbud slave 20 can generate payload information of a TWS reply control packet and transmit the TWS reply control packet to the earbud master 10 in response to receiving the TWS start control packet from the earbud master 10. The earbud slave 20 can update Rx parameter (ARQN, SEQN, Payload counter, and AFH Channel Map) information for the reception operation of the next snooping link according to the snooping information of the received TWS start control packet.

The earbud master 10 receives the TWS reply control packet transmitted from the earbud slave 20, and based on the relay information of the corresponding payload, can determine whether the earbud slave 20 has data for which snooping has failed.

The earbud master 10 can determine whether data relay operation is necessary based on the relay information it has and the relay information transmitted by the earbud slave 20. The earbud master 10 can determine whether the earbud slave 20 has data for which snooping has failed based on the relay information it has and the relay information transmitted by the earbud slave 20.

The earbud master 10 can determine that data relay is not necessary if there is no data for which snooping has failed, and can determine that data relay is necessary if there is data for which snooping has failed.

The earbud master 10 assumes that the earbud slave 20 determines that data relay is necessary because there is data that has failed to be snooped.

The earbud master 10 determines that data relay is necessary and can transmit the packet payload that has failed to be snooped to the earbud slave 20 by loading it into a TWS relay packet.

The earbud slave 20 can perform data relay based on the received TWS relay packet. The earbud slave 20 can transmit a null packet (including an ACK) to the earbud master 10 in response to the received TWS relay packet.

After the earbud master 10 completes transmission of all TWS relay packets that should be data relayed and reception of ACKs in response, it can generate a payload of a TWS end control packet and transmit the generated packet to the earbud slave 20.

When the earbud slave 20 receives a TWS end control packet, it recognizes that the data relay operation is no longer necessary and can switch to a snooping link operation for receiving an ACL data packet from the source device 1.

When the earbud master 10 receives a null packet (including ACK) in response to the transmitted TWS end control packet, it can terminate the TWS control link operation and switch to an ACL link operation for receiving an ACL data packet from the source device 1.

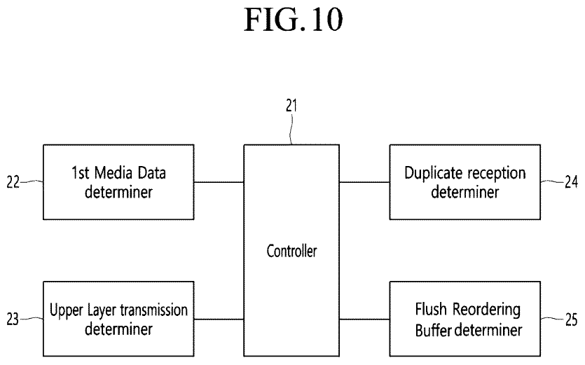

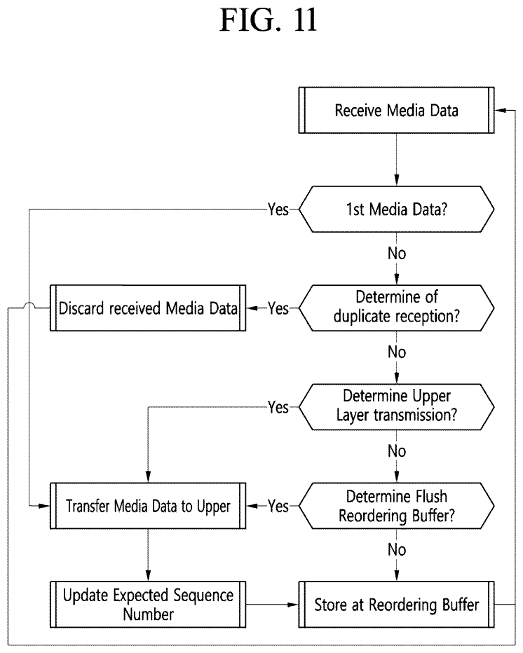

Referring to FIGS. 10 and 11, an operation method in the case where the earbud slave 20 receives the same data repeatedly will be described. Specifically, when the earbud master 10 fails to receive an ACL data packet and the earbud slave 20 succeeds in snooping, the earbud master 10 transmits a NACK message to the source device 1, so that the earbud slave 20 can receive the same ACL data packet repeatedly as the source device 1 retransmits the ACL data packet. In this case, the operation method of the earbud slave 20 is described. FIG. 10 is a control block diagram of an earbud slave device according to an embodiment of the present disclosure, and FIG. 11 is a flowchart illustrating a method in which the earbud slave device according to an embodiment of the present disclosure determines the duplicate reception of an ACL data packet and operates.

As illustrated in FIG. 10, the earbud slave according to the embodiment of the present disclosure, i.e., the earbud slave 20, may include at least some or all of the controller 21, the first media data determiner 22, the upper layer transmission determiner 23, the duplicate reception determiner 24, and the flush reordering buffer determiner 25.

The controller 21 may control each of the first media data determination unit 22, the upper layer transmission determiner 23, the duplicate reception determiner 24, and the flush reordering buffer determiner 25.

As illustrated in FIG. 11, the first media data determiner 22 may determine whether the received media data is the first data when media data is received. Here, the media data may be an ACL data packet, but is not limited thereto.

If the first media data determiner 22 determines that the received media data is the first data, it can transmit the received media data to the upper layer transmission determiner 23 and wait for the next media data. On the other hand, if the first media data determiner 22 determines that the received media data is not the first data, it can transmit the received media data to the duplicate reception determiner 24.

If the duplicate reception determiner 24 determines that the received media data is identical to previously received data or identical to data currently stored in the reordering buffer, it can discard the received media data. On the other hand, if the duplicate reception determiner 24 determines that the received media data is not duplicate received data, it can transmit the received media data to the upper layer transmission determiner 23.

If the sequence number of the received media data is the same as the expected sequence number, the upper layer transmission determiner 23 can transmit the corresponding media data to the upper layer and increase the value of the expected sequence number by ‘1’.

If the sequence number of the received media data is different from the expected sequence number, the upper layer transmission determiner 23 can transfer the corresponding layer to the flush reordering buffer determiner 25.

The flush reordering buffer determiner 25 can determine whether to perform flushing of the reordering buffer. The flush reordering buffer determiner 25 can determine whether to delete data stored in the reordering buffer.

The flush reordering buffer determiner 25 can determine whether the sequence number of the received media data matches all the expected sequence numbers in the reordering buffer. The flush reordering buffer determiner 25 may transmit all data in the reordering buffer to the upper layer and increase the value of all expected sequence numbers in the reordering buffer by ‘1’ if the sequence number of the received media data does not match any expected sequence number in the reordering buffer and the sequence number of the received media data is greater than the maximum value of all expected sequence numbers in the reordering buffer. The flush reordering buffer determiner 25 may store the received media data in the reordering buffer if the sequence number of the received media data matches at least one expected sequence number in the reordering buffer.

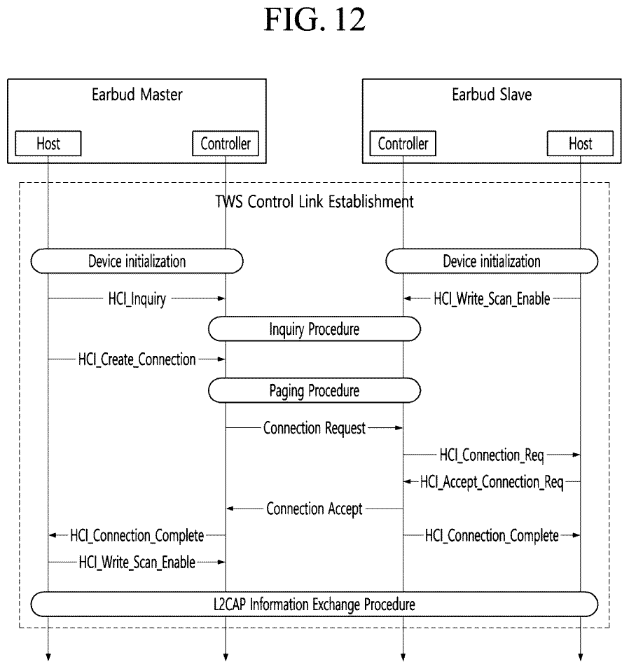

FIG. 12 is a flowchart illustrating a process of forming a TWS control link between an earbud master and an earbud slave according to an embodiment of the present disclosure.

Referring to FIG. 12, a method of forming a TWS control link between an earbud master 10, which is an earbud master, and an earbud slave 20, which is an earbud slave, will be described.

The earbud master 10 can wait for a response from the earbud slave 20 through the HCI_Inquiry command after the device initialization process. The earbud slave 20 can enter the inquiry scan mode of the earbud master 10 through the HCI_Write_Scan_Enable command after the device initialization.

In the inquiry scan mode, inquiry and page scan can be enabled. That is, the page scan mode can be entered immediately after the inquiry procedure.

The inquiry procedure between the earbud master 10 and the earbud slave 20 is performed, and the earbud master 10 that receives the inquiry response from the earbud slave 20 can attempt an ACL connection through the HCI_Create_Connect command. This may be an earbud master page scan mode.

When a paging procedure is performed between the earbud master 10 and the earbud slave 20, and the earbud slave 20 sends a connection acceptance, and the earbud master 10 receives this, the TWS control link setup between the earbud master 10 and the earbud slave 20 may be completed.

After this, the earbud master 10 may enter an inquiry scan mode through the HCI_Write_Scan_Enable command for ACL connection with a source device 1, such as a smart phone.

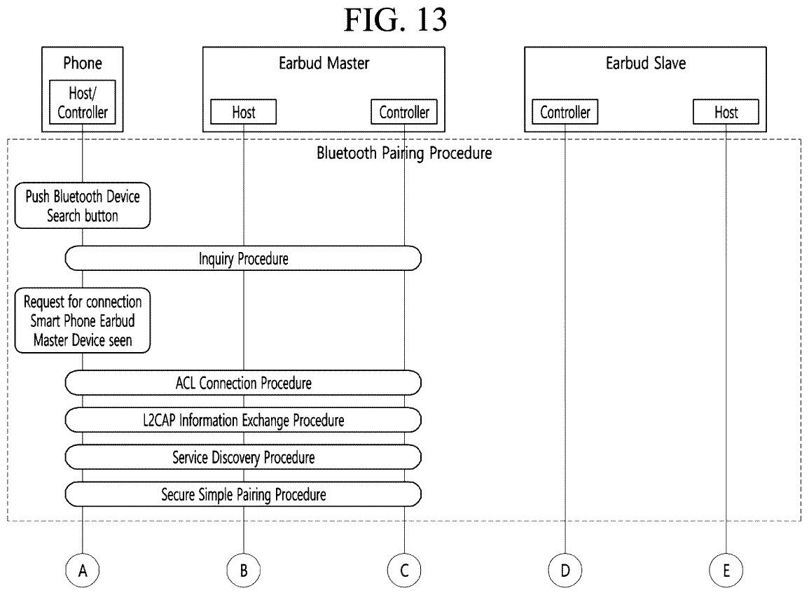

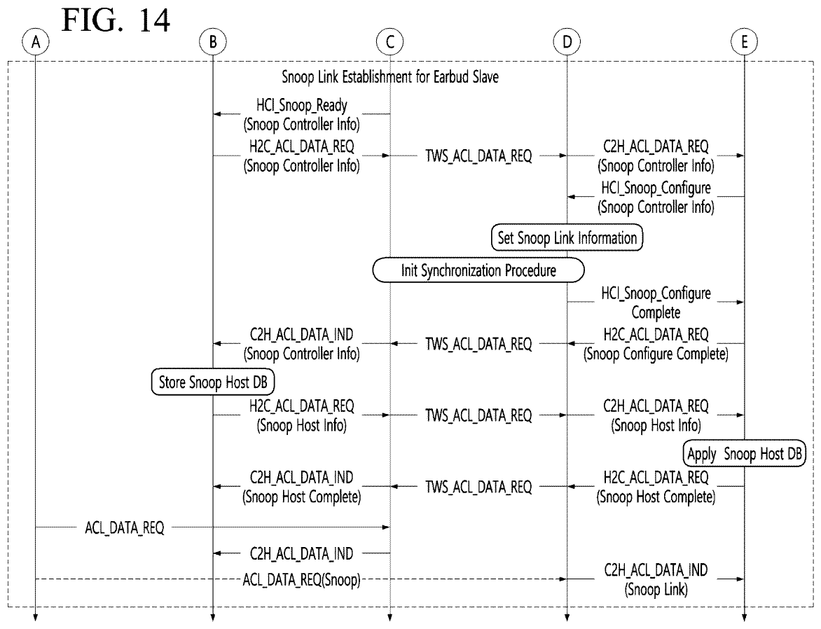

FIGS. 13 to 14 are flowcharts illustrating a method of connecting and exchanging information between earbuds according to an embodiment of the present disclosure.

The earbud master 10 can establish a TWS snooping link that allows the earbud slave 20 to receive ACL data transmitted from the source device 1.

Referring to FIG. 12, first, the earbud master, i.e., the earbud master 10, can perform a Bluetooth pairing procedure with the source device 1. When Secure Simple Pairing is completed in the earbud master 10 and Link Key generation is completed, the HCI_Snoop_Ready (New) Event can be transmitted to the host of the earbud master 10 to inform the earbud slave 20 that the snooping link can be set. At this time, the HCI_Snoop_Ready (New) Event may include controller information of the earbud master 10 for setting up a snooping link.

The host of the earbud master 10 may transmit snooping controller information through a TWS control link with the earbud slave 20 that has been previously set up. The host of the earbud slave 20 may transmit the received snooping controller information to the controller of the earbud slave 20 through the HCI_Snoop_Configure (New) command. The controller of the earbud slave 20 may set the received snooping controller information and perform an initial synchronization procedure, and then notify the host of the earbud slave 20 that the snooping controller link setting has been completed through the HCI_Snoop_Configure_Complete Event. The host of the earbud slave 20 can transmit the completion of the Snoop Controller Configure to the host of the earbud master 10. The host of the earbud master 10 can store the host configuration information of the source device 1 and the earbud master 10 that has been set so far, and transmit it to the host of the earbud slave 20. The host of the earbud slave 20 applies the host configuration information of the source device 1 and the first sink device 1 that have been transmitted, and after transmitting Snoop Host Complete to the earbud master 10, the earbud slave 20 can receive the data sent by the source device 1 through the Snoop Link.

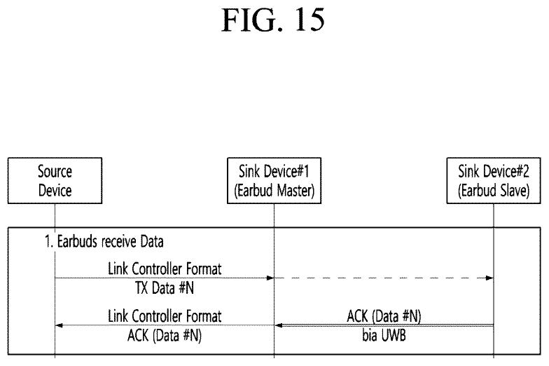

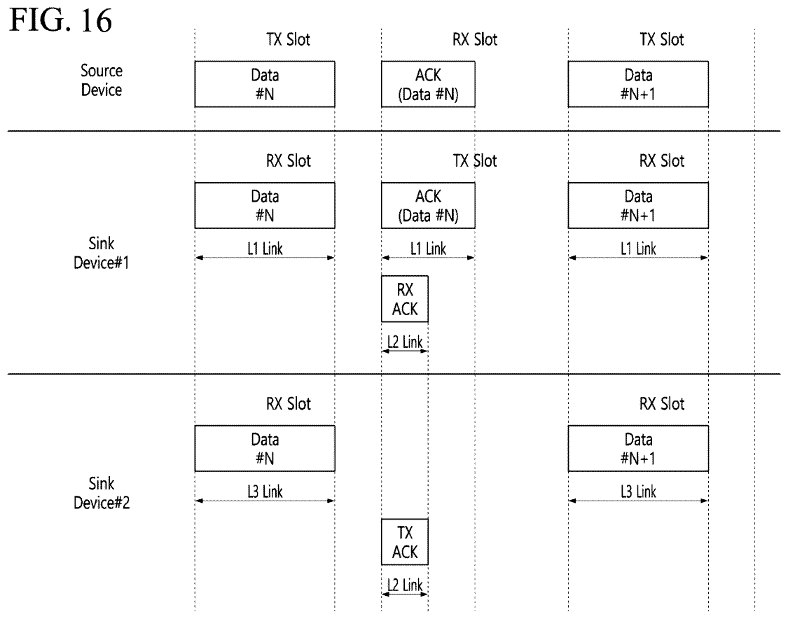

FIG. 15 is a flowchart illustrating a method for normally transmitting and receiving data using heterogeneous link technology in a wireless earbud system according to an embodiment of the present disclosure, and FIG. 16 is a diagram illustrating a data transmission/reception and ACK timing diagram according to FIG. 15.

Up to now, the process of establishing a TWS control link between an earbud master 10 and an earbud slave 20 via Bluetooth has been described. That is, the earbud master 10 can communicate with the source device 1 via Bluetooth, and the earbud master 10 can communicate with the earbud slave 20 via Bluetooth.

FIG. 15 and FIG. 16 illustrate a case where Ultra Wide Band (UWB) is used instead of Bluetooth for the TWS control link. The earbud master 10 can communicate with the source device 1 via Bluetooth, and the earbud master 10 can communicate with the earbud slave 20 via UWB.

The earbud master 10 can transmit a message about the success/failure of receiving ACL data to the source device 1 via Bluetooth communication, and at the same time, can receive a message about the success/failure of snooping of the earbud slave 20 from the earbud slave 20.

Data and Ack transmitted using Bluetooth are indicated as L1 link, and the TWS Control Link generated between the earbud master 10 and the earbud slave 20 using UWB, a heterogeneous link technology, is indicated as L2 link. The L3 link may be a link for snooping data from the source device 1.

If both the earbud master 10 and the earbud slave 20 normally receive data from the source device 1, the earbud master 10 can transmit an ACK to the source device 1 through the L1 link, which is a Bluetooth data link, and at the same time, the earbud slave 20 can notify the earbud master 10 of the normal reception of Data #N through the L2 link, which is a TWS control link.

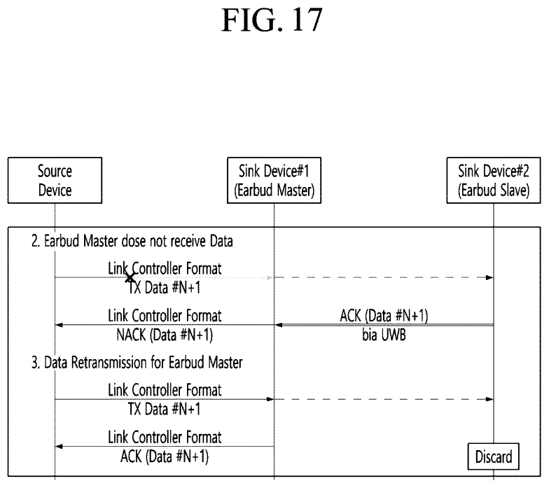

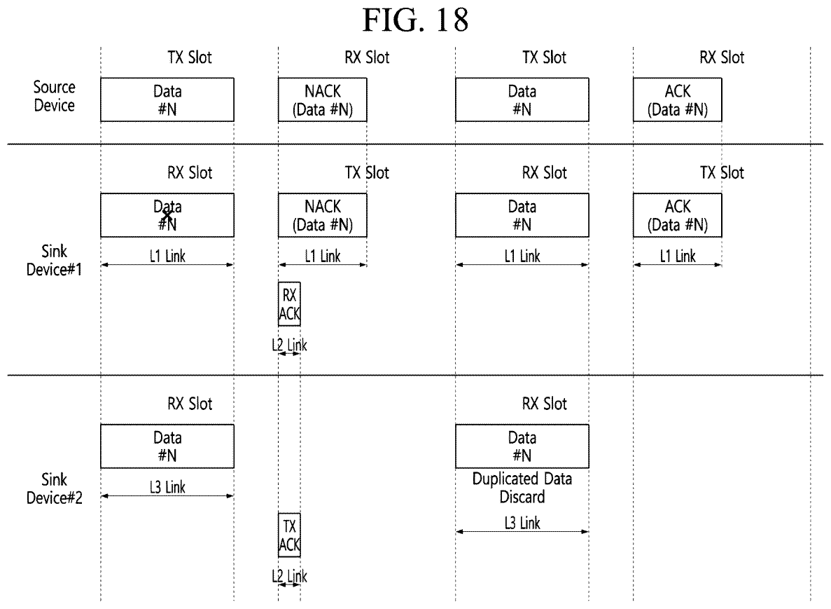

FIG. 17 is a flowchart illustrating a case in which only the earbud master does not receive data when utilizing heterogeneous link technology in a wireless earbud system according to another embodiment of the present disclosure, and FIG. 18 is a diagram illustrating a data transmission/reception and ACK timing diagram according to FIG. 17.

The earbud master 10 does not receive data from the source device 1, and only the earbud slave 20 can successfully snoop on data transmitted from the source device 1. In this case, the earbud master 10 can retransmit data from the source device 1 through a Bluetooth retransmission procedure. If the earbud slave 20 succeeds in snooping the data retransmitted from the source device 1, it can ignore the data.

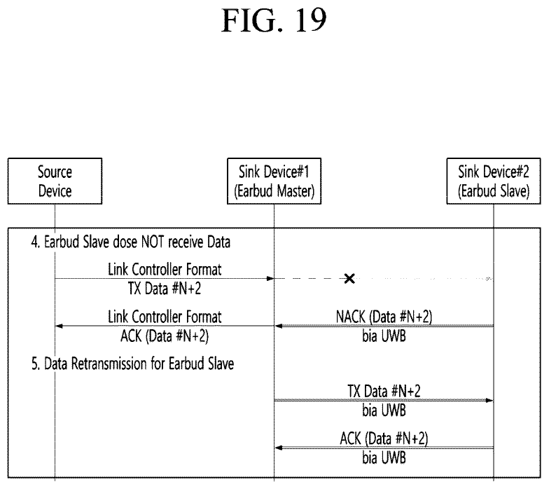

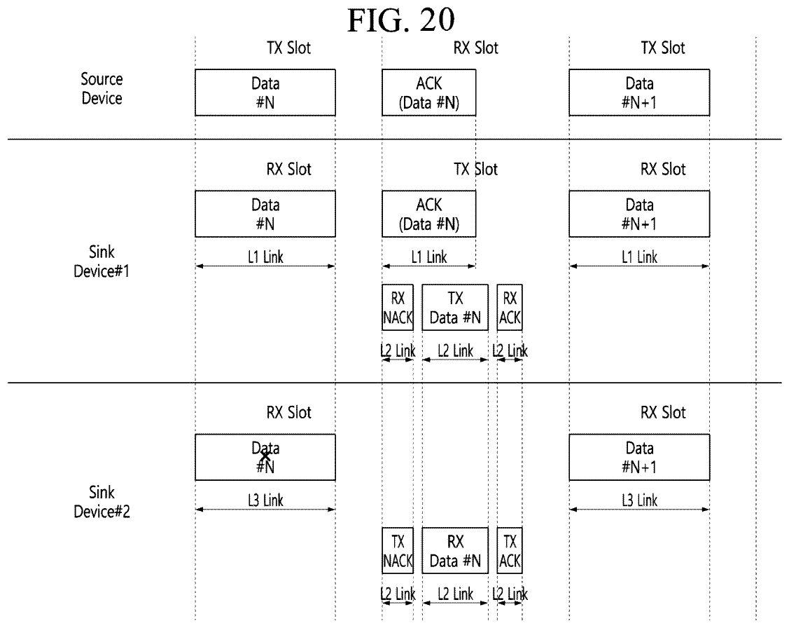

FIG. 19 is a flowchart illustrating a case in which only the earbud slave does not receive data when utilizing heterogeneous link technology in a wireless earbud system according to another embodiment of the present disclosure, and FIG. 20 is a diagram illustrating a data transmission/reception and ACK timing diagram according to FIG. 19.

The earbud master 10 may receive data, and only the earbud slave 20 may not receive data. In this case, the earbud slave 20 may transmit a NACK message to the earbud master 10 through the L2 link.

The earbud master 10 can perform data retransmission, i.e., relay, based on the NACK information of the earbud slave 20 received through the L2 link while notifying the source device 1 of its normal data reception through the L1 link. At this time, the number of relay attempts can be adjusted by setting the retransmission allowance time.

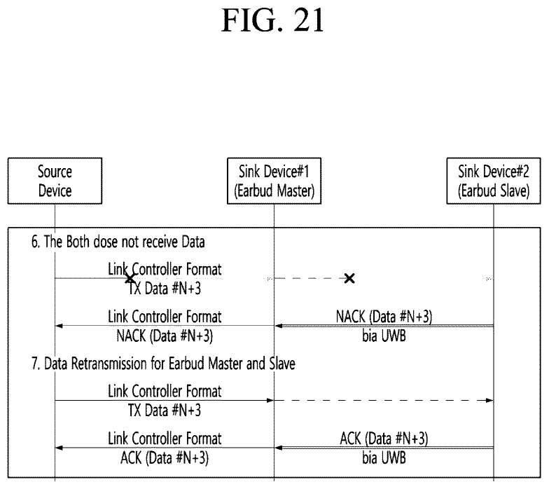

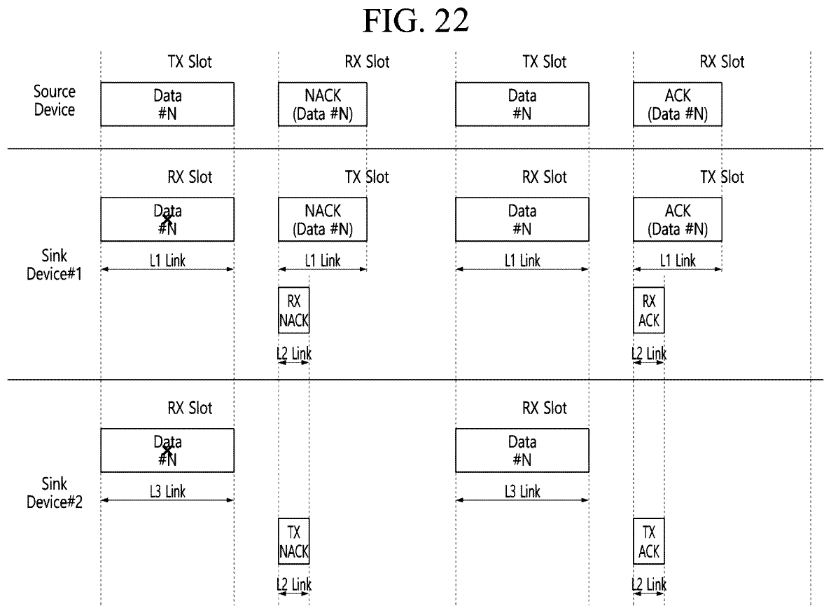

FIG. 21 is a flowchart illustrating a case where both the earbud master 10 and the earbud slave 20 do not receive data when utilizing heterogeneous link technology in a wireless earbud system according to another embodiment of the present disclosure, and FIG. 22 is a diagram illustrating a data transmission/reception and ACK timing diagram according to FIG. 21.

If both the earbud master 10 and the earbud slave 20 fail to receive data, the earbud master 10 transmits a NACK message to the source device 1 through the L1 link, and can simultaneously receive a NACK message from the second sink device 20 through the L2 link. Accordingly, if both the earbud master 10 and the earbud slave 20 fail to receive data, the earbud master 10 also fails to receive data, so the data can be recovered by retransmitting data by the source device 1 without performing relay.

In this way, by utilizing the heterogeneous link technology, ACK signals can be transmitted and received simultaneously, and thus, there is an advantage of minimizing the latency problem.

Next, the operation method of the wireless earbud system is described in detail. The wireless earbud system according to one embodiment of the present disclosure can selectively perform data relay.

Hereinafter, a method for synchronizing playback time in an earbud system having a snooping and retransmission (or relay) structure, that is, a method for setting and transmitting/receiving synchronization information between earbud master/slave, using network time between earbud master/slave (not between source device/earbud master), setting playback time considering a retransmission section, a method for sharing information based on a packet for entering and exiting a retransmission section, a method for processing a packet before setting synchronization information, a method for processing time error due to clock drift caused by long-term operation, etc. are described.

First, a description is given of the synchronization of playback time in the wireless earbud system according to the present disclosure. Here, time synchronization may refer to the fact that the earbud master and earbud slave 20 constituting the wireless earbud system reproduce data received using the snooping method according to the present disclosure at the same time.

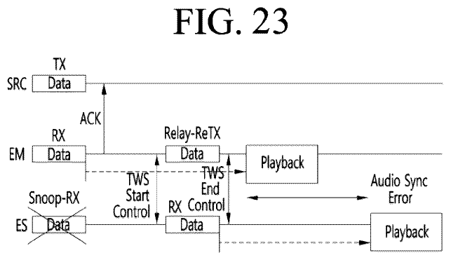

FIG. 23 is a diagram illustrating a synchronization error in the wireless earbud system according to an embodiment of the present disclosure.

The wireless earbud system uses a relay or snooping method to connect the source device 1 (e.g., an audio source) and the earbud master 10 and the earbud slave 20, i.e., two earbuds. As described above, considering battery consumption and delay time, a unique snooping method, i.e., an optional relay technology of the controller, may be used.

Referring to FIG. 23, in this snooping method, the earbud master 10 selectively retransmits data to the earbud slave 20 instead of the source device (SRC) 1. In this case, there is a difference in the reception processing time for audio data (data packets) that should be played at the same time in the earbud master 10 and the earbud slave 20, and as a result, an audio playback sync error problem may occur between the earbud master 10 and the earbud slave 20.

Meanwhile, when playing audio for a long time, a clock drift phenomenon may occur due to the use of individual clocks between the source device 1 and the earbud master 10 (and the earbud slave 20). Clock drift may also be one of the causes of audio sync errors, and a solution for this is required.

Referring to FIGS. 1 and 23, the earbud slave 20 is a method of snooping the communication between the source device 1 and the earbud master 10. Meanwhile, the earbud slave 20 can transmit ACK information to the earbud master 10 in the TWS control section of the controller. The earbud master 10 can retransmit packet relay, that is, packets missed by the earbud slave 20, based on the statistics of the earbud slave 20. Since the controller exchanges retransmission information, the time error due to retransmission may not be large.

However, as illustrated in FIG. 23, synchronization, that is, synchronization, may be required when the initial retransmission occurs, and consideration needs to be given to the possibility of the aforementioned clock drift occurring even during long-term operation.

The present disclosure can utilize control packets exchanged between the earbud master and the earbud slave in the retransmission section for the aforementioned synchronization and processing due to clock drift.

For example, the playback time of each data packet received from the source device 1 can be determined by the earbud master 10. If the earbud slave 20 does not know the playback time of the received packet, it is preferable not to play it. However, defining the playback time for each data packet and transmitting it may be inefficient in terms of system efficiency.

Therefore, in the present disclosure, in order for the earbud master 10 and the earbud slave 20 to play at the same time, that is, to match the playback synchronization, the maximum retransmission time and the subsequent audio processing time can be considered, not the time at which the data packet is received.

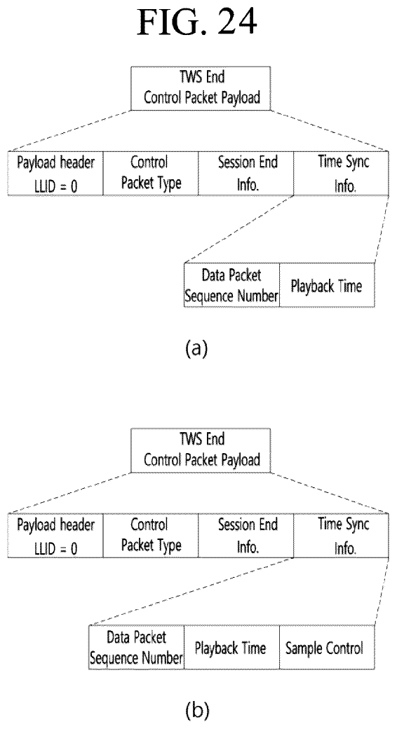

FIG. 24 is a diagram illustrating the payload format of a TWS End Control Packet according to another embodiment of the present disclosure.

A wireless earbud according to at least one embodiment of the various embodiments of the present disclosure may be configured to include an earbud master 10 that receives audio data from a source device 1 and an earbud slave 20 that snoops audio data transmitted from the source device 1.

The earbud master 10 may transmit synchronization information related to the reproduction (e.g., reproduction time) of a data packet to the earbud slave 20.

The earbud master 10 may include synchronization information in a control packet transmitted to the earbud slave 20. The control packet may be a TWS end control packet. However, the present disclosure is not limited thereto. For example, the earbud master 10 may transmit sync information to the earbud slave 20 in a packet other than the TWS end control packet, or may generate a separate packet including sync information and transmit it to the earbud slave 20.

In FIG. 24(a) or 24(b), another embodiment of a TWS end control packet including sync information is illustrated.

Unlike the TWS end control packet illustrated in FIG. 6, the TWS end control packet illustrated in FIG. 24(a) or 24(b) further includes sync information. Therefore, when explaining the TWS end control packet illustrated in FIG. 24(a) or 24(b), the content already explained in FIG. 6 above will be referred to, and any redundant explanation will be omitted here.

First, the TWS end control packet illustrated in FIG. 24(a) includes sync information, and the sync information may include the following information.
Data Packet Sequence Number (DataSN): It can indicate the reference sequence number (Sequence Number) for performing time synchronization.
Playback Time (32 bit): It can indicate the time when the data packet is actually played. At this time, the actual time when the data packet is played can use the network time applied between the earbud master 10 and the earbud slave 20.

The sync information can be configured to include information about the data packet sequence number (DataSN) and the playback time (T_{playback}, playback time) as shown in FIG. 24(a).

The data packet sequence number information (DataSN) can indicate the reference sequence number of the data packet to which the sync information is applied. At this time, the reference sequence of the data packet to which the sync information is applied can be the first sequence of the data packet to which the sync information is applied, but is not necessarily limited thereto.

The playback time information (T_{playback}) can indicate the point in time at which the reference sequence of the data packet is actually played. The playback time information (T_{playback}) can be defined using the network time applied between the earbud master 10 and the earbud slave 20.

Meanwhile, the sync information can be defined by considering the retransmission section due to the snooping failure of the earbud slave 20 in the earbud master 10.

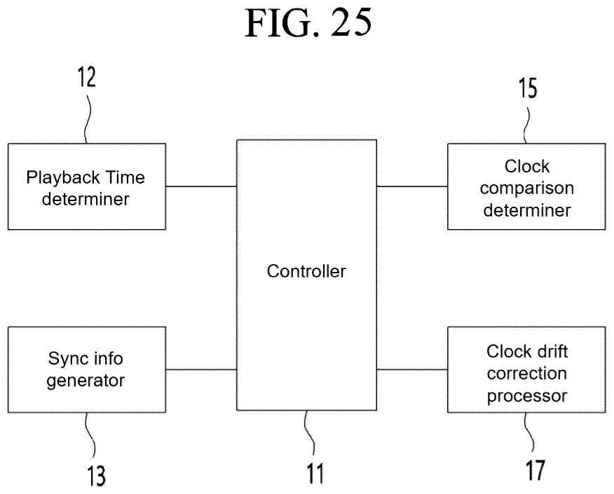

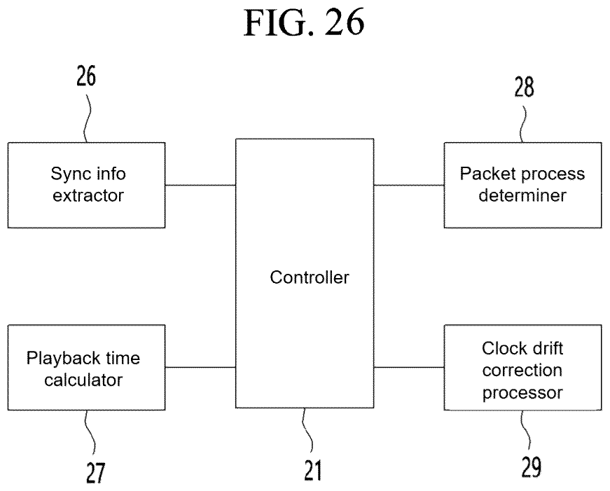

Referring to FIGS. 25 and 26, an operation for setting sync information (synchronization information) between an earbud master 10 and an earbud slave 20 and resolving a clock drift phenomenon is described.

FIG. 25 is a control block diagram of an earbud master 10 device according to an embodiment of the present disclosure, and FIG. 26 is a control block diagram of an earbud slave 20 device according to an embodiment of the present disclosure.

As illustrated in FIG. 25, an earbud master 10 according to an embodiment of the present disclosure may include some or all of a controller 11, a playback time determiner 12, a sync information generator 13, a clock comparison determiner 15, and a clock drift correction processor 17.

The controller 11 can control the operation of each of the playback time determiner 12, the sync information generator 13, the clock comparison determiner 15, and the clock drift correction processor 17.

The playback time determiner 12 can determine the playback time of the received data packet. The received data packet may indicate the reference sequence number of the data packet to which the sync information is applied, that is, DataSN as shown in FIG. 24(a), but is not limited thereto. Meanwhile, the playback time is a time defined using the network time applied between the earbud master 10 and the earbud slave 20, and may indicate T_{playback} as shown in FIG. 24(a).

The sync information generator 13 can generate sync information for information on the playback time of the data packet determined by the playback time determiner 12.

The clock comparison determiner 15 can extract and compare the clock information used in the controller of the earbud master 10 with the clock of the Bluetooth modem (Bluetooth™ Modem Clock) applied between the source device 1 to determine whether clock drift occurs due to long-term operation, thereby determining whether clock drift occurs.

The clock drift correction processor 17 can perform an operation for time correction according to the clock drift that has occurred if it is determined through the clock comparison determiner 15 that clock drift has occurred.

In response to the operation of the earbud master 10 of FIG. 25, FIG. 26 describes the operation of the earbud slave 20.

As illustrated in FIG. 26, the earbud slave 20 according to the embodiment of the present disclosure may include some or all of the controller 21, the sync information extractor 26, the playback time calculator 27, the packet processing determiner 28, and the clock drift correction processor 29.

The controller 21 may control the operation of each of the sync information extractor 26, the playback time calculator 27, the packet processing determiner 28, and the clock drift correction processor 29.

The sync information extractor 26 may extract a sync information field from a TWS control end packet received from the earbud master 10, and may extract sync information by parsing the sync information field. At this time, the extracted sync information may include the sync information illustrated in FIG. 24(a) or FIG. 24(b).

The playback time calculator 27 can calculate the playback time point of the earbud slave 20 that matches the playback sync of the earbud master 10 based on the sync information extracted from the sync information extractor 26.

The packet processing determiner 28 can determine the processing method for packets received before the packet playback time and missing packets based on the packet playback time of the earbud slave 20 calculated by the playback time calculator 27, and can perform an operation accordingly. For example, in the former case, as described below, packets received by the earbud slave 20 before the playback time are ignored (ignore or discarded) so as not to be played, and in the latter case, as described below, if a packet that should be played by the earbud slave 20 at the playback time is missing, it can be processed as silence.

The clock drift correction processor 29 can perform an operation for time correction according to the clock drift that has occurred when it is determined through the clock comparison determiner 15 that a clock drift has occurred.

The operating method of a wireless earbud according to at least one embodiment of various embodiments of the present disclosure can be performed by including a process in which the earbud master 10 receives audio data from a source device 1, the earbud slave 20 snoops audio data transmitted from the source device 1 to the earbud master 10, and the earbud master 10 transmits sync information related to data packet playback to the earbud slave 20.

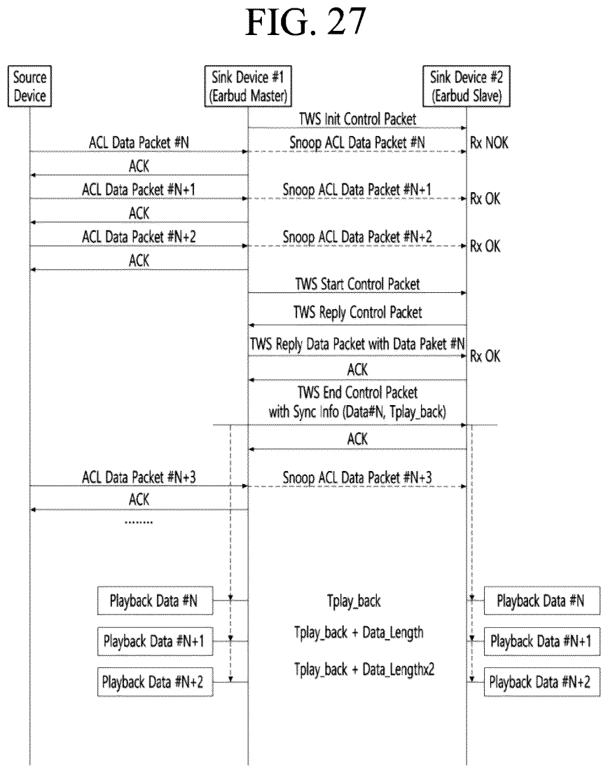

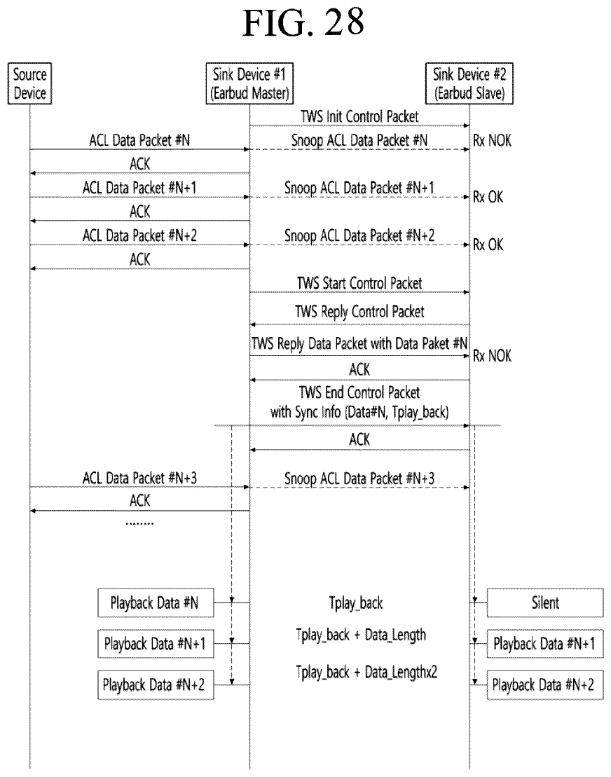

In explaining the operation method of FIGS. 27 and 28 below, the overlapping part with the operation method described in FIGS. 7 to 9 above will be referred to the corresponding description, and the overlapping description will be omitted here. In other words, the description before the part of transmitting the TWS end control packet from the earbud master 10 to the earbud slave 20 will be referred to the above, and the description below will be made from the part of transmitting the TWS end control packet including the sync information.

FIG. 27 is a flowchart illustrating the operation method when the data relay of the wireless earbud system according to the embodiment of the present disclosure is not required.

The earbud master 10 transmits the TWS end control packet to the earbud slave 20.

The TWS end control packet may include sync information, as illustrated in FIG. 24(a). The sync information may include information on the data packet to be played back later (Data #N) and the playback time information (T_{playback}) of the data packet.

In the above, the playback time can be calculated as in the following mathematical expression 1. The time information used in the mathematical expressions 1 and 2 described below can be used based on the network time applied by connecting between the earbud master 10/slave 20.

$${T}_{playback} = {T}_{TWS \_ End \_ Control} + {T}_{Delay} \qquad [ Mathematical expression 1 ]$$

Here, T_{tws_end_control} can use the slot boundary that transmits the corresponding control message.

T_{Delay} can be the total time required for data processing.

Referring to mathematical expression 1, the playback time (T_{playback}) can be calculated by considering the delay (T_{Delay}) at the time when the TWS end control packet is transmitted (T_{TWS_End_Control}). At this time, the delay (T_{Delay}) may represent a delay time according to the performance of at least one operation among hardware decoding (HW Decoding), software processing (SW Processing), and audio decoding time (Audio Decoding Time), for example. The earbud master 10 may play Data #N at the T playback point.

The playback time of the data packet after Data #N may be calculated by the following mathematical expression 2.

$${T}_{playback \_ Data ( N + K )} = {T}_{playback} + {T}_{Data Length \times K} \qquad [ Mathematical expression 2 ]$$

Referring to mathematical expression 2, the playback time (T playback_Data (N+K)) of any data packet (e.g., the kth) after Data #N may be a value obtained by adding the time corresponding to the length of one data packet based on the playback time (T_{playback}) of Data #N. At this time, K may be an arbitrary value and may be a natural number. Therefore, the playback time of any Kth data packet, i.e., T_{playback_Data(N+K)}, can be determined by adding the value obtained by multiplying k by the length of each data packet from the playback time (T playback) of the first data packet. Referring to mathematical expressions 1 and 2, the information (Data #N, T_{playback}) where T_{playback}=T_{tws_end_control}+T_{Delay} can be extracted through the sync information. At this time, through mathematical expression 2, when k=1, i.e., Data #N+1 can be calculated as T_{playback}+T_{data_length*1}, and when k=2, i.e., the playback time of Data #N+2 can be calculated as T_{playback}+T_{data_length*2}.

According to an embodiment, the earbud master 10 can include only the playback time information (T_{playback}) of the first data packet calculated by mathematical expression 1 in the sync information and transmit it to the earbud slave 20. In this case, the earbud slave 20 extracts the playback time information (T_{playback}) of the first data packet from the sync information, and can calculate the playback time of the remaining data packets based on the playback time information of the extracted first data packet through mathematical expression 2.

According to another embodiment, the earbud master 10 can include the playback time information (T_{playback}) of the first data packet calculated by mathematical expression 1 and the playback time information (T_{playback_Data(N+K)}) of any data packet calculated by mathematical expression 2 in the sync information and transmit it to the earbud slave 20. In this case, the earbud slave 20 extracts the playback time information (T_{playback}) of the first data packet from the sync information, calculates the playback time of any data packet through mathematical expression 2, and compares it with the playback time information (T_{playback_Data(N+K)}) of any data packet included in the sync information, thereby preventing the synchronization from being mismatched in the middle. Meanwhile, the earbud slave 20 may verify the sync information through the aforementioned comparison. For example, if the playback times of arbitrary data packets do not match each other as a result of the aforementioned comparison, the earbud slave 20 may determine that the reliability of the sync information transmitted from the earbud master 10 is low and request retransmission.

Meanwhile, the earbud slave 20 may ignore or discard the data packets received and stored in the buffer before the playback time of the first playback data packet, i.e., Data #N, without playing them.

According to another embodiment, the earbud master 10 may generate a separate TWS control packet including sync information (packet sequence number and playback time) for an arbitrary packet to be played at an arbitrary point in time (not indicating a playback time point in time) and transmit it to the earbud slave 20.

Meanwhile, the earbud master 10 can transmit a TWS control packet in a specific unit to match the playback sync with the earbud slave 20. At this time, the specific unit may be at least one of a song unit, a program unit, a time unit, etc., for example. Alternatively, the specific unit may represent a section in which data packets are continuously received from the source device 1. In this case, if a data packet is not received from the source device 1 and then received again, a TWS control packet may be transmitted to match the sync. Accordingly, if a TWS control packet is transmitted from the earbud master 10 to the earbud slave 20, the above-described process may be re-performed.

FIG. 27 can be viewed as a case in which, for example, the earbud slave 20 successfully receives an ACL data packet retransmitted from the earbud master 10 (RX OK).

The earbud master 10 can update the sync information database (Sync Info Database) based on the first packet successfully received (Data #N, None).

When the time point of transmitting the TWS end control packet is determined, the earbud master 10 can determine the playback time (T_{play_back}) of each packet based on that time point.

The earbud master 10 can transmit (Data #N, _{Tplay_back}) information together with the sync information in the TWS end control packet.

The earbud master 10 can play at the playback time of each data packet.

Meanwhile, the earbud slave 20 can snoop the data packet and then pending it in the buffer.

And when the earbud slave 20 receives the sync information in the TWS end control packet, it can calculate the playback time based on the sync information and play.

FIG. 28 is a flowchart illustrating an operation method in the case of initial clock synchronization of a wireless earbud system according to another embodiment of the present disclosure.

The aforementioned FIG. 27 may be a description of a processing method in the case where the earbud slave 20 successfully receives an ACL data packet retransmitted from the earbud master 10 (RX OK), or FIG. 28 may be a description of a processing method in the case where the earbud slave 20 fails to receive an ACL data packet retransmitted from the earbud master 10 (RX NOK).

In FIG. 28, the description of the overlapping portion with the aforementioned FIG. 27 may be cited and the overlapping description may be omitted here.

The earbud slave 20 may pending the data packet in a buffer after snooping it.

The earbud slave 20 extracts sync information from the TWS end control packet transmitted from the earbud master 10, calculates the playback time using the aforementioned mathematical expression 1, and can play the data packet (Data #N) from that time.

However, unlike FIG. 27, referring to FIG. 28, if the earbud slave 20 does not receive a packet (e.g., Data #N) corresponding to the sync information (RX NOK), the packet can be processed as silent. However, for the playback time of the subsequent packet, the earbud slave 20 can calculate the playback time of an arbitrary packet (e.g., Data #N+1) using the aforementioned mathematical expression 2, and play the packet at that playback time so that the playback sync with the earbud master 10 does not deviate.

That is, according to at least one embodiment among the various embodiments of the present disclosure, the earbud slave 20 can ignore a data packet having a sequence number earlier than the reference sequence number of the data packet to which the sync information is applied. If the data packet corresponding to the sync information is not received, the earbud slave 20 can process the packet as silent.

Hereinafter, clock fine tuning according to the occurrence of clock drift is described.

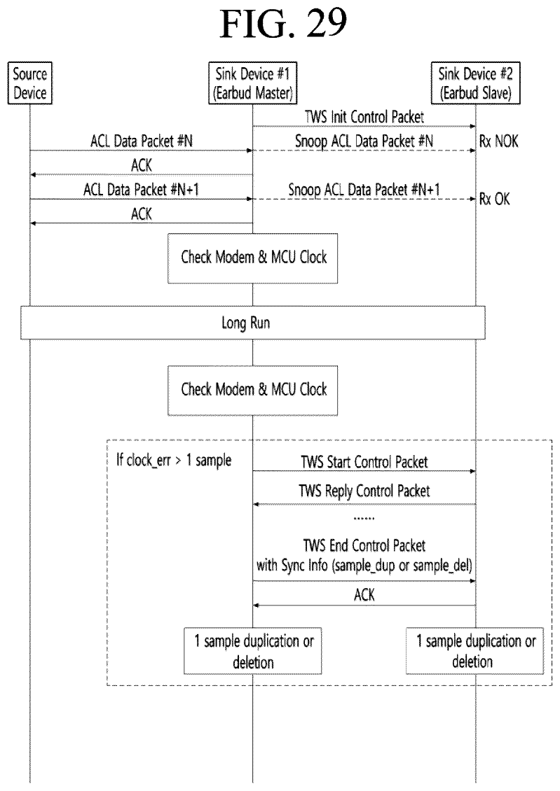

FIG. 29 is a flowchart illustrating an operation method for clock fine tuning of a wireless earbud system according to an embodiment of the present disclosure.

Hereinafter, the present disclosure describes a packet retransmission process between earbuds used in a Bluetooth snooping process and a processing method for reducing a playback time error between earbuds that may occur due to clock drift.

The earbud master 10 can determine whether a clock drift occurs by determining whether a difference occurs between the clock of the Bluetooth modem (Bluetooth™ Modem Clock) applied between the source device 1 and the clock used by the controller of the earbud master 10, and if a difference occurs, the amount of change in the difference. If a clock drift occurs, the earbud master 10 performs a correction operation, and can finely adjust the amount of change in the difference between the clocks, for example, in units of audio samples.

In relation to performing the correction operation, the earbud master 10 can use sync information. At this time, the sync information can be included in the TWS control packet. For example, the TWS end control packet as shown in FIG. 24(b) can be used as the TWS control packet. Referring to FIG. 24(b), the sync information may further include the following information in addition to the sync information defined in FIG. 24(a).
Sample Control: It can indicate information for adding or deleting a sample.

The sample disclosed in the present disclosure can be used based on sample data of Pulse-code modulation (PCM) data, but is not necessarily limited thereto. At this time, the sample control information can be included in the TWS end control packet illustrated in FIG. 24(b), and can be used for the aforementioned clock drift.

In the earbud according to the embodiment of the present disclosure, time error processing due to clock drift occurrence can be performed as follows.

The earbud master 10 can monitor the error between the clock of the Bluetooth modem and the clock of the controller to determine whether clock drift has occurred. At this time, the monitoring can be performed periodically or aperiodically at an arbitrary point in time. For example, the monitoring can be performed based on the TWS control packet exchanged between the earbud master 10 and the earbud slave 20. For example, if the earbud master 10 transmits a TWS control packet to the earbud slave 20 a predetermined number of times (every m times, where m is a natural number), clock monitoring can be performed.

After that, the earbud master 10 can share clock drift-related information with the earbud slave 20 using the control packets transmitted and received in the retransmission section, and can process the time error accordingly by correcting it. This may be to prevent the playback sync from being misaligned due to the correction when the correction is performed only in the earbud master 100 or the earbud slave 20.

According to at least one embodiment of the various embodiments of the present disclosure, the first sink device compares the network time applied between the source device 1 and the clock of the controller, and if there is a difference greater than a threshold, performs a correction operation based on the sample control information, wherein the threshold is determined based on an audio sample of PCM data, and the sample control information may include control information for overlapping at least one sample in the PCM data if the clock of the controller is faster than the network time, and control information for deleting at least one sample in the PCM data if the clock of the controller is slower than the network time.

A more detailed description of the clock fine tuning operation method for clock drift processing is as follows.

The earbud master 10 may monitor the difference (clock_err) between the Bluetooth modem clock and the clock of the controller. At this time, the monitoring may be performed periodically/aperiodically by the earbud master 10.

The earbud master 10 can determine that a clock drift phenomenon has occurred between the source device 1 and the earbud master 10 if the difference (clock_err) between the two clocks is greater than a predefined threshold as a result of the monitoring. Accordingly, the earbud master 10 can perform a correction operation to resolve the determined clock drift phenomenon. At this time, the correction operation can refer to the sample control information in the sync information illustrated in FIG. 24(b).

The earbud master 10 determines whether a clock drift has occurred based on a threshold, and the threshold can be defined in advance based on PCM data that is audio decoded. The threshold can be defined based on a sample unit of the PCM data. According to an embodiment of the present disclosure, the threshold can be defined as 1 sample, but is not necessarily limited thereto. Accordingly, the earbud master 10 can perform a correction operation by adding or deleting a sample. The earbud master 10 can extract at least one sample of PCM data and add a sample by duplicating the extracted sample. On the other hand, the earbud master 10 can extract at least one sample of PCM data and delete the sample by deleting the extracted sample. However, the correction operation by the earbud master 10 is not limited to the sample duplication or sample deletion described above. For example, as one of the correction operations, sample deletion may extract a target sample and mute the extracted target sample to produce the same effect. Meanwhile, in the above, the sample selected for sample duplication or sample deletion for the correction operation may be determined by the earbud master 10 and may be arbitrarily selected. For example, the earbud master 10 may extract a sample whose audio level is below a certain level and duplicate or delete it, or vice versa. In the above, the use of a sample whose audio level is below a certain level is intended to minimize the influence on the correction operation, and the present disclosure is not necessarily limited thereto.

If the difference (clock_err) between the two clocks is at least 1 sample, the earbud master 10 can perform a correction operation by duplicating or deleting samples from the PCM data.

As shown in FIG. 24(b), the earbud master 10 can transmit sync information including sample control information to the earbud slave 20 by including it in the TWS end control packet. Then, when the earbud slave 20 receives the TWS end control packet received from the earbud master 10, it parses it, and if the sync information includes sample control information, it can extract the sample control information and perform the same processing as the earbud master 10 on the PCM data to be played back by the earbud slave 20.

When the earbud master 10 transmits the TWS end control packet including the sample control information as shown in FIG. 24(b), it can define information on sample deletion or sample duplication so that it is in sync with the earbud slave 20. In addition, when the earbud master 10 defines information on sample deletion or sample duplication, it can include identifier information on the sample to be deleted or duplicated so that it is in sync with the earbud slave 20.

When the earbud master 10 is connected to the earbud slave 20/source device 1, it can periodically compare the network time connected to the source device 1 and the clock of the controller of the earbud master 10.

When the difference (clock_err) between the network time applied between the source device 1 and the clock of the controller is greater than or equal to a threshold as a result of the comparison, the earbud master 10 can correct the difference. At this time, the threshold can be defined as, for example, at least 1 audio sample or more, but is not necessarily limited thereto.

If the clock of the controller is determined to be faster than the network time with the source device 1, control can be made so that at least 1 sample is duplicated in the PCM data.

On the other hand, if the clock of the controller is determined to be slower than the network time with the source device 1, control can be made so that at least 1 sample is deleted in the PCM data.

Correction information (sync info) is sent in the TWS end control packet, and the earbud master 10 and the earbud slave 20 perform a correction operation on the first packet played after the TWS end control packet and play it.

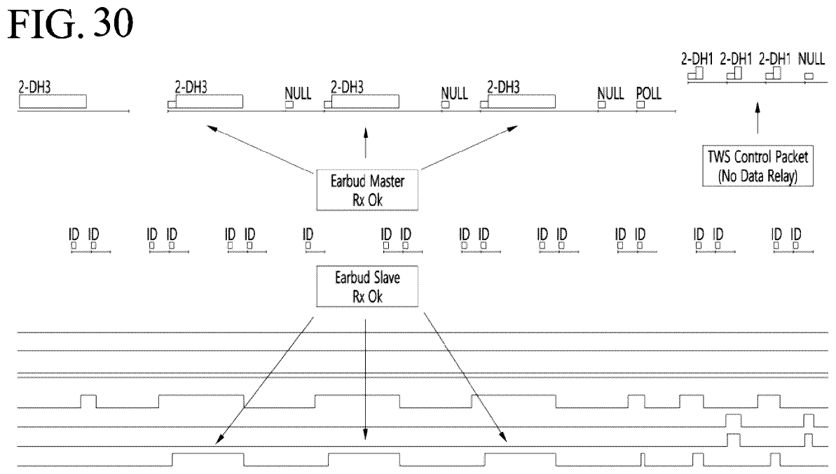

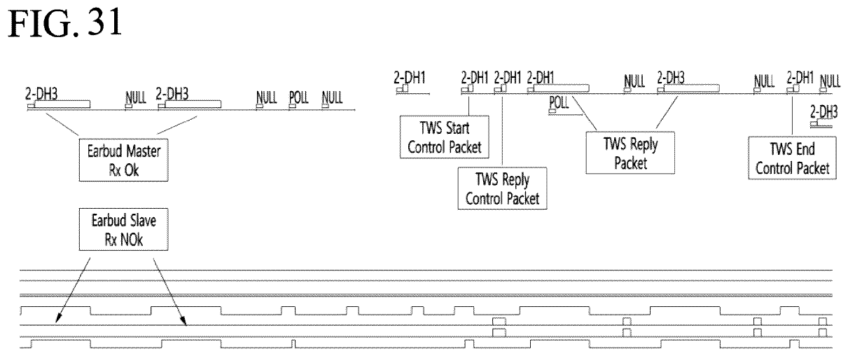

FIG. 30 is a drawing illustrating a packet captured by an air sniffer device when data relay is not required in a wireless earbud system according to an embodiment of the present disclosure, and FIG. 31 is a drawing illustrating a packet captured by an air sniffer device when data relay is required in a wireless earbud system according to an embodiment of the present disclosure.

Referring to FIG. 30, since the earbud master 10 normally receives data and the earbud slave 20 also normally receives data, it can be confirmed that TWS control packets are transmitted and received without a data relay.

Meanwhile, referring to FIG. 31, while the earbud master 10 normally receives data, the earbud slave 20 may not receive data. Accordingly, it can be confirmed that after the earbud master 10 transmits the TWS start control packet, the TWS reply control packet is received, and at least one TWS relay control packet and a TWS end control packet are transmitted.

According to the present disclosure described above, the flight playback time error can be further improved (for example, the playback time error <150 us), and the playback time error (clock drift) increase due to long-term operation can also be further improved (the playback time error increase <150 us). However, the effect according to the present disclosure is not necessarily limited to the above-mentioned numerical value.

According to at least one of the various embodiments of the present disclosure, since the earbud master 10 selectively transmits only the data that was not received from the earbud slave 20 to perform data relay, the relay frequency and delay time are minimized, and accordingly, there is an advantage of improving battery efficiency. According to at least one of the various embodiments of the present disclosure, it is possible to improve the playback time error to be zero or minimized, and to prevent or improve the playback time error that may occur due to the clock drift phenomenon during long-term operation, thereby improving the convenience of using wireless earbuds.

The above-described present disclosure can be implemented as a computer-readable code on a medium in which a program is recorded. The computer-readable medium includes all kinds of recording devices in which data that can be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed as limiting in all aspects and should be considered as illustrative. The scope of the present disclosure should be determined by a reasonable interpretation of the appended claims, and all changes within the equivalent scope of the present disclosure are included in the scope of the present disclosure.

The above description is merely an example of the technical idea of the present invention, and those with ordinary knowledge in the technical field to which the present invention belongs may make various modifications and variations without departing from the essential characteristics of the present invention.

Therefore, the embodiments disclosed in the present invention are not intended to limit the technical idea of the present invention, but to explain it, and the scope of the technical idea of the present invention is not limited by these embodiments.

The protection scope of the present invention should be interpreted by the claims below, and all technical ideas within the equivalent scope should be interpreted as being included in the scope of the rights of the present invention.

### INDUSTRIAL APPLICABILITY

According to the wireless earbuds according to the present disclosure, the frequency and delay time of data relay between earbuds can be minimized, and battery consumption can be minimized, and the case of mismatch in playback sync between earbuds can be prevented, thereby improving the convenience of use, and thus, there is industrial applicability.

1-15. (canceled)

16. A wireless earbud comprising:
a first sink device configured to receive audio data from a source device; and
a second sink device configured to snoop the audio data transmitted from the source device,
wherein the first sink device is configured to transmit synchronization information related to the playback of a data packet to the second sink device, wherein the first sink device includes the synchronization information in a control packet transmitted to the second sink device, wherein the synchronization information includes at least one of a data packet sequence number, information on a playback time and information on sample control.

17. The wireless earbud of claim 16, wherein the control packet is a True Wireless Stereo end control packet.

18. A wireless earbud comprising:
a first sink device configured to receive audio data from a source device; and
a second sink device configured to snoop the audio data transmitted from the source device,
wherein the first sink device is configured to transmit synchronization information related to the playback of a data packet to the second sink device, wherein the first sink device includes the synchronization information in a control packet transmitted to the second sink device, wherein the synchronization information includes at least one of a data packet sequence number, information on a playback time and information on sample control, wherein the data packet sequence number information indicates a reference sequence number of a data packet to which the synchronization information is applied.

19. The wireless earbud of claim 18, wherein the first sink device is configured to compare the network time applied between the source device with a clock of a controller and when the difference exceeds a threshold, and perform a correction operation based on the sample control information,
wherein the threshold is determined based on an audio sample of Pulse-code modulation (PCM) data, and
wherein the sample control information includes:
when the clock of the controller is faster than the network time, duplicate control information including at least one sample in the PCM data, and
when the clock of the controller is slower than the network time, deletion control information including at least one sample in the PCM data.

20. The wireless earbud of claim 18, wherein the reference sequence of the data packet to which the synchronization information is applied is a first sequence of the data packet to which the synchronization information is applied.

21. The wireless earbud of claim 18, wherein the playback time information indicates a time point where the reference sequence of the data packet is actually played.

22. The wireless earbud of claim 20, wherein the playback time information is defined using network time applied between the first sink device and the second sink device.

23. The wireless earbud of claim 20, wherein the second sink device is configured to discard a data packet having a sequence number earlier than the reference sequence number of the data packet to which the synchronization information is applied.

24. A wireless earbud comprising:
a first sink device configured to receive audio data from a source device; and
a second sink device configured to snoop the audio data transmitted from the source device,
wherein the first sink device is configured to transmit synchronization information related to the playback of a data packet to the second sink device, wherein the first sink device includes the synchronization information in a control packet transmitted to the second sink device, wherein the synchronization information includes at least one of a data packet sequence number, information on a playback time and information on sample control, wherein the synchronization information is defined considering a retransmission interval due to a snooping failure of the second sink device.

25. The wireless earbud of claim 24, wherein when a data packet corresponding to the synchronization information is not received, the second sink device is configured to process the corresponding packet as silent.
